(19) United States
(12) Patent Application Publication
(10) Pub. No.: US 2016/0283818 A1
(43) Pub. Date: Sep. 29, 2016

(54) METHOD AND APPARATUS FOR EXTRACTING SPECIFIC REGION FROM COLOR DOCUMENT IMAGE

(71) Applicant: FUJITSU LIMITED, Kawasaki (JP)

(72) Inventors: Wei LIU, Beijing (CN); Wei FAN, Beijing (CN); Jun SUN, Beijing (CN)

(73) Assignee: FUJITSU LIMITED, Kawasaki (JP)

(21) Appl. No.: 15/058,752

(22) Filed: Mar. 2, 2016

(30) Foreign Application Priority Data
Mar. 9, 2015 (CN) 201510101426.0

(51) Int. Cl. H04N 1/46; G06K 9/34; H04N 1/04; G06K 9/46; G06K 9/00

(52) U.S. Cl. CPC G06K 9/4652; G06K 9/34; G06K 9/344; G06K 9/00463; G06K 9/4604; G06K 9/342; H04N 1/0408; G06K 2009/4666; G06K 2209/01

(57) ABSTRACT

A method and apparatus for extracting a specific region from a color document image where the method includes: obtaining a first edge image according to the color document image; acquiring a binary image using non-uniformity of color channels; merging the first edge image and the binary image to obtain a second edge image; and determining the specific region according to the second edge image. The method and apparatus according to the invention can separate a picture region, a half-tone region, and a closed region bound by lines, in the color document image from a normal text region with high precision and robustness.

### CROSS REFERENCE TO RELATED APPLICATION

This application relates to the subject matter of the Chinese patent application for invention, Application No. 201510101426.0, filed with Chinese State Intellectual Property Office on Mar. 9, 2015. The disclosure of this Chinese application is considered part of and is incorporated by reference in the disclosure of this application.

### FIELD OF THE INVENTION

The present invention generally relates to the field of image processing. Particularly, the invention relates to a method and apparatus for extracting a specific region from a color document image with higher accuracy and robustness.

### BACKGROUND OF THE INVENTION

In recent years, the technologies related to scanners have been developed rapidly. For example, those skilled in the art have made their great efforts to improve the processing effect of bleed-through detection and removal, a document layout analysis, optical character recognition, and other technical aspects of a scanned document image. However, only the improvements in these aspects may not be sufficient. The effect of the various processes on the scanned document image can be improved efficiently as a whole if a preprocessing step of those aspects, i.e., division of the scanned document image into regions, is improved.

The variety of contents of the scanned document image results in the difficulty of processing. For example, frequently the scanned document image is colored, and includes alternately arranged texts and pictures, and sometimes bounding boxes. These regions have different characteristics from each other, and thus it has been difficult to process them uniformly. However, it may be necessary to extract the various regions highly precisely and robustly to thereby improve the effect of subsequent processes. FIG. 1 illustrates an example of the color scanned document image, particular color details thereof will be described below.

A traditional algorithm for dividing into and extracting regions typically designed for a very particular issue may not be versatile, so if it is applied to a different particular issue, it may be difficult to extract regions highly precisely and robustly. Apparently, this may not accommodate a method for dividing into and extracting regions as preprocessing of bleed-through detection and removal, a document layout analysis, optical character recognition, and other technical aspects.

In view of this, there is a need of a method and apparatus for extracting a specific region from a color document image, especially a color scanned document image, which can extract a specific region, particularly a picture region, a half-tone region, and a closed region bound by lines, in the color document image highly precisely and robustly to thereby distinguish these regions from a text region.

### SUMMARY OF THE INVENTION

The following presents a simplified summary of the invention in order to provide basic understanding of some aspects of the invention. It shall be appreciated that this summary is not an exhaustive overview of the invention. It is not intended to identify key or critical elements of the invention or to delineate the scope of the invention. Its sole purpose is to present some concepts in a simplified form as a prelude to the more detailed description that is discussed later.

In view of the problem above in the prior art, an object of the invention is to provide a method and apparatus for extracting a specific region from a color document image highly precisely and robustly.

In order to attain the object above, in an aspect of the invention, there is provided a method for extracting a specific region from a color document image, the method including: obtaining a first edge image according to the color document image; acquiring a binary image using non-uniformity of color channels; merging the first edge image and the binary image to obtain a second edge image; and determining the specific region according to the second edge image.

According to another aspect of the invention, there is provided an apparatus for extracting a specific region from a color document image, the apparatus including: a first edge image acquiring device configured to obtain a first edge image according to the color document image; a binary image obtaining device configured to acquire a binary image using non-uniformity of color channels; a merging device configured to merge the first edge image and the binary image to obtain a second edge image; and a region determining device configured to determine the specific region according to the second edge image.

According to a further aspect of the invention, there is provided a scanner including the apparatus for extracting a specific region from a color document image as described above.

Furthermore, according to another aspect of the invention, there is further provided a storage medium including machine readable program codes which cause an information processing device to perform the method above according to the invention when the program codes are executed on the information processing device.

Moreover, in a still further aspect of the invention, there is further provided a program product including machine executable instructions which cause an information processing device to perform the method above according to the invention when the instructions are executed on the information processing device.

### BRIEF DESCRIPTION OF THE DRAWINGS

The above and other objects, features and advantages of the invention will become more apparent from the following description of the embodiments of the invention with reference to the drawings. The components in the drawings are illustrated only for the purpose of illustrating the principle of the invention. Throughout the drawings, same or like technical features or components will be denoted by same or like reference numerals. In the drawings:

FIG. 1 illustrates an example of a color document image;

FIG. 2 illustrates a flow chart of a method for extracting a specific region from a color document image according to an embodiment of the invention;

FIG. 3 illustrates an example of a first edge image;

FIG. 4 illustrates an example of a binary image;

FIG. 5 illustrates an example of a second edge image;

FIG. 6 illustrates an example of a third edge image;

FIG. 7 illustrates a flow chart of a method for determining a specific region;

FIG. 8 illustrates an example of a bounding rectangle surrounding a region;

FIG. 9 illustrates a flow chart of a method for determining a specific region;

FIG. 10 illustrates a mask image corresponding to an extracted specific region;

FIG. 11 illustrates a structural block diagram of an apparatus for extracting a specific region from a color document image according to an embodiment of the invention; and

FIG. 12 illustrates a schematic block diagram of a computer in which the method and the apparatus according to the embodiments of the invention can be embodied.

### DETAILED DESCRIPTION OF THE INVENTION

Exemplary embodiments of the invention will be described below in details with reference to the drawings. For the sake of clarity and conciseness, not all the features of an actual implementation will be described in this specification. However, it shall be appreciated that in the development of any such actual implementation, numerous implementation-specific decisions shall be made to achieve the developers' specific goals, such as compliance with system-related and business-related constraints, which will vary from one implementation to another. Moreover, it shall be appreciated that such a development effort might be complex and time-consuming, but will nevertheless be a routine undertaking for those of ordinary skill in the art having the benefit of this disclosure.

It shall be further noted here that only the apparatus structures and/or process steps closely relevant to the solution according to the invention are illustrated in the drawings, but other details less relevant to the invention have been omitted, so as not to obscure the invention due to the unnecessary details. Moreover, it shall be further noted that an element and a feature described in one of the drawings or the embodiments of the invention can be combined with an element and a feature illustrated in one or more other drawings or embodiments.

A general idea of the invention lies in that a specific region, such as a picture region, a half-tone region, a closed bound by lines, etc., is extracted from a color document image using both color and edge (e.g., gradient) information.

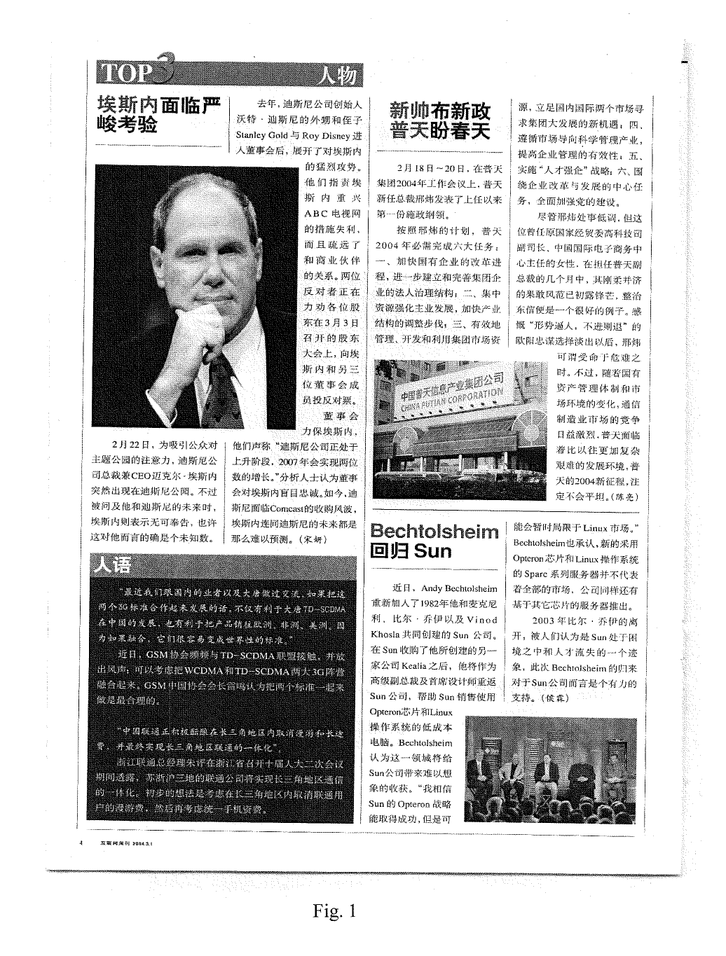

An input to the method and apparatus according to the invention is a color document image. FIG. 1 illustrates an example of a color document image, where “TOP 3 [symbol] ” at the top left corner is both a region surrounded by a bounding frame and a half-tone region. The portrait below “TOP 3 [symbol] ” is both a half-tone region and a picture region. “ [symbol] ” below the portrait and the four paragraphs of words therebelow are both regions surrounded by bounding frames and half-tone regions. The “ [symbol] [symbol] ” photo in the middle on the right side, and the picture including five persons at the bottom right corner are both half-tone regions and picture regions. “ [symbol] ” at the top left corner, “ [symbol] ” at the top in the middle, and “Bechtolsheim” around the center are color texts. All the other contents are black texts in the white background, white blanks, and black open lines. An object of the invention is to extract the regions where “TOP 3 [symbol] ”, the portrait, “ [symbol] ” and the four paragraphs of words therebelow, the “ [symbol] [symbol] ” photo, and the picture including the five persons at the top left corner are located, to thereby distinguish them from the remaining normal text regions, where the color texts “ [symbol] [symbol] ”, “ [symbol] ”, and “Bechtolsheim” shall be categorized as the normal text regions.

As can be apparent from FIG. 1, the image to be processed is complex in that the image includes a variety of elements with different characteristics from each other, and thus may be rather difficult to process.

The specific region to be extracted in the invention includes at least one of a picture region, a half-tone region, and a closed region bound by lines. As described above with respect to FIG. 1, some region is one of the three regions, or two or three of the three regions. The specific region precludes a non-picture region, a non-color region, and an open region even if there are lines on a part of edges of such regions. For example, there are vertical lines on both the left and right sides of the text block on the left side below the portrait in FIG. 1, but this region is not closed, so it shall be determined as a normal text region.

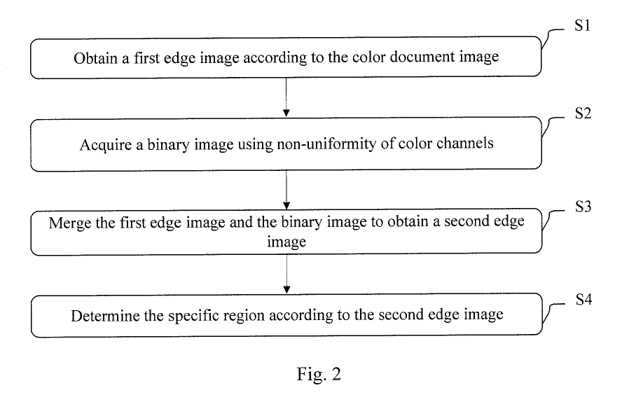

A flow of a method for extracting a specific region from a color document image according to an embodiment of the invention will be described below with reference to FIG. 2.

FIG. 2 illustrates a flow chart of a method for extracting a specific region from a color document image according to an embodiment of the invention. As illustrated in FIG. 2, the method for extracting a specific region from a color document image according to the embodiment of the invention includes the steps of: obtaining a first edge image according to the color document image (step S1); acquiring a binary image using non-uniformity of color channels (step S2); merging the first edge image and the binary image to obtain a second edge image (step S3); and determining the specific region according to the second edge image (step S4).

In the step S1, a first edge image is obtained according to the color document image.

An object of the step S1 is to obtain edge information of the image, so the step S1 can be performed in a method known in the prior art for extracting an edge.

According to a preferred embodiment of the invention, the step Si can be performed in the following steps S101 to S103.

Firstly, in the step S101, the color document image is converted into a grayscale image. This conversion step is well known to those skilled in the art, so a repeated description thereof will be omitted here.

Then, in the step S102, a gradient image is obtained according to the gradient image using convolution templates.

Particularly, the grayscale image is scanned using a first convolution template to obtain a first intermediate image. The first convolution template is

```
  28
125
206
125
  28,
```

for example. First five pixels from the top in the first column starting from the left of the grayscale image are aligned with the first convolution template, where pixel values, i.e., grayscale values, of these five pixels are multiplied respectively by corresponding weights 28, 125, 206, 125, and 28 of the first convolution template, and then averaged as the center of these five pixels, which is the value of a corresponding pixel in the first intermediate image, which corresponds to the third pixel from the top in the first column of the grayscale image. The first convolution template is displaced to the right side by one pixel position relative to the grayscale image so that the first convolution template corresponds to the first five pixels from the top in the second column starting from the left of the grayscale image, and the calculation above is repeated so as to obtain the value of a corresponding pixel in the first intermediate image, which corresponds to the third pixel from the top in the second column of the grayscale image, and so on until the first to fifth rows of the grayscale image are scanned by the first convolution template. Next, the second to sixth rows of the grayscale image are further scanned by the first convolution template, and so on until the last first to fifth rows of the grayscale image are scanned by the first convolution template, thus resulting in the first intermediate image.

It shall be noted that all the first convolution template here, and a second convolution template, a third convolution template, and a fourth convolution template below are examples. All the sizes and weights of the convolution templates are examples, and the invention will not be limited thereto.

Then, the first intermediate image is scanned by the second convolution template to obtain a horizontal gradient image. The second convolution template is

| | | | | | | |
|---|---|---|---|---|---|---|
| −54 | −86 | −116 | 0 | 116 | 86 | 54, |

for example,

Next, the grayscale image is scanned by the third convolution template to obtain a second intermediate image. The third convolution template is

| | | | | |
|---|---|---|---|---|
| 28 | 125 | 206 | 125 | 28, |

for example.

Next, the second intermediate image is scanned by the fourth convolution template to obtain a vertical gradient image. The fourth convolution template is

```
−54
−86
−116
  0
116
  86
  54,
```

for example. The scanning processes of the second, the third and the fourth convolution template are similar to that of the first convolution template.

Then, the absolute values of corresponding pixels in the horizontal gradient image and the vertical gradient image are compared so that the gradient image is consisted of larger ones thereof.

Finally, in the step S103, the pixels in the gradient image are normalized and binarized to obtain the first edge image. The normalization and binarization steps are well known to those skilled in the art, so a repeated description thereof will be omitted here. A binarization threshold can be set flexibly by those skilled in the art.

According to a preferred embodiment of the invention, the step S1 can alternatively be performed in the following steps S111 to S113.

In the step S111, the color document image is converted into R, G and B single channel images.

In the step S112, R, G and B single channel gradient images are obtained according to the R, G and B single channel images using a convolution template. Since each of the R, G and B single channel images is similar to the color document image, the step S112 can be performed similarly to the steps S101 and S102 above.

In the step S113, respective pixels in the R, G and B single channel gradient images are 2-Normed, normalized and binarized into the first edge image. Stated otherwise, three values of the respective pixels in the R, G and B single channel gradient images are merged into single values so that the three single channel gradient images are merged and converted into the first edge image.

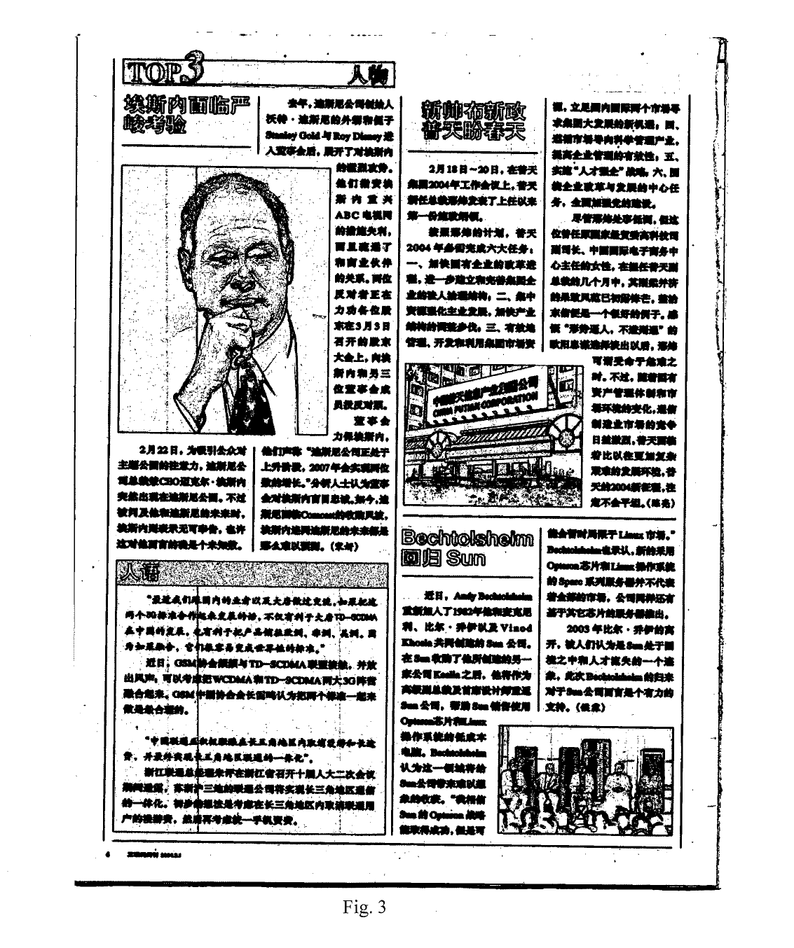

The first edge image has been obtained from the color document image through the step S1. FIG. 3 illustrates an example of the first edge image. In binarization, if a pixel in the first edge image corresponds to a pixel above the binarization threshold, then the pixel in the first edge image will be 0; otherwise, it will be 1. Of course, 0 and 1 are only examples and other settings can be performed.

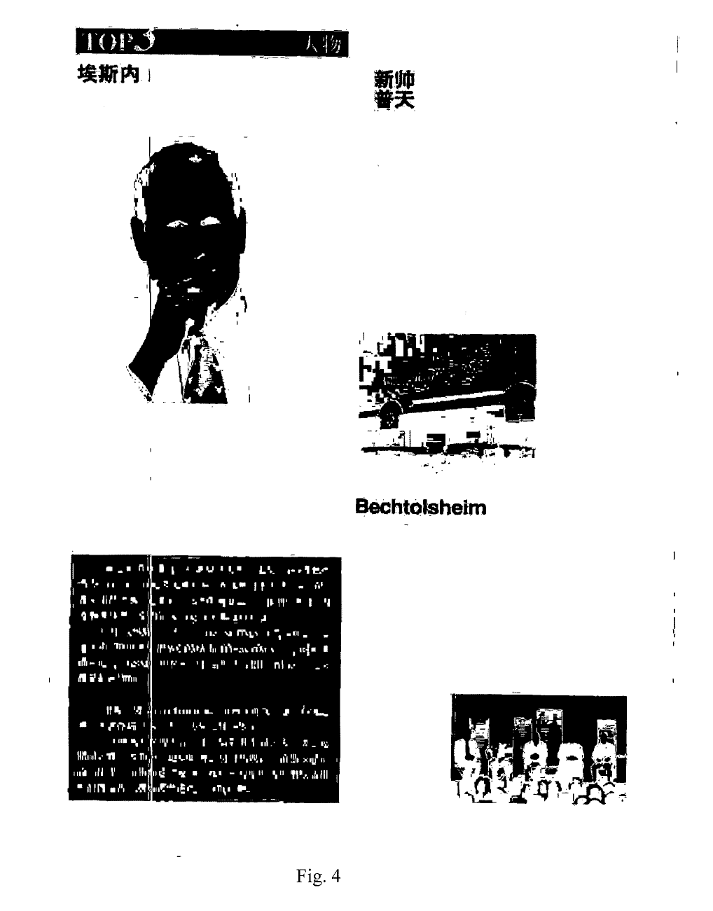

The first gradient image can reflect the majority of edges in the color document image, particularly edges including black, white and gray pixels. However it may be difficult for the first gradient image to reflect light color zones in the color document image (for example, the background behind the five persons at the bottom right corner in FIG. 1 is color but light, and thus is determined as the background in FIG. 3 but is determined as the foreground in FIG. 4 generated in the step S2 to be described below) because there is not a sharp grayscale characteristic of these zones. Thus, an inherent color characteristic is needed for extracting a half-tone region, a color picture region, etc.

As described above, the invention extracts a specific region from the color document image using both color and edge (gradient) information. Thus, color information needs to be acquired.

There are a number of formats of the color document image, e.g., the RGB format, the YCbCr format, the YUV format, the CMYK format, etc. The following description will be given taking the RGB format as an example. It shall be noted that the color image in the other formats can be converted into the RGB format as well known in the prior art for the following exemplary process.

In the step S2, a binary image is obtained using non-uniformity of color channels.

An object of this step is to obtain color information of the color image, more particularly color pixels in the color document image. The principle thereof lies in that if the values of three R, G and B color channels are the same or their difference is insignificant, then the color will be presented in gray (if all of them are 0, then the color will be pure black, and if all of them are 255, then the color will be pure white), and if the difference among the three R, G and B color channels is significant, then the color will be presented in a variety of colors. The significance or insignificance of the differences can be evaluated against a preset difference threshold.

Particularly, firstly the difference among the three R, G and B channels of each pixel in the color document image can be compared. For example, for each pixel (r₀, g₀, b₀), three channels of the pixel are calculated as d₀=r₀−(g₀+b₀)/2; d₁=g₀−(r₀+b₀)/2; d₂=b₀−(r₀+g₀)/2. Next, max(abs(d₀), abs(d₁), abs(d₂)) is calculated, where max ( ) represents the maximum thereof, and abs ( )represents the absolute value thereof, that is, the maximum of the absolute values of d₀, d₁, d₂ is calculated to characterize the difference among the three R, G and B channels of the pixel.

Then, the value of a pixel in the binary image, which corresponds to the pixel is determined according to whether the difference is above a first difference threshold. Stated otherwise, if the difference of three R, G and B channels of a pixel in the color document image is above the first difference threshold, a pixel in the binary image, which corresponding to the pixel will be 0, for example; otherwise, the pixel in the binary image will be 1. Of course, other settings can be performed. It shall be noted that the foreground in the first edge image obtained in the step S1 needs to be represented with the same value as the foreground in the binary image obtained in the step S2 so that the foreground in the first edge image can be merged with the foreground in the binary image in the step S3. FIG. 4 illustrates an example of the binary image.

Since there is always a significant difference among three R, G and B channels of a color pixel, a light color pixel difficult to extract in the step S1 can be extracted in the step S2. Also since the non-uniformity of color channels is utilized in the step S2, black, white and gray pixels will be difficult to process. Thus, primarily the black, white and gray pixels are processed using the edge information in the step S1. As can be apparent, a better effect of extracting the regions as a whole can be achieved using both the color and edge information.

In the step S3, the first edge image and the binary image are merged to obtain a second edge image.

Particularly, if at least one of corresponding pixels in the first edge image and the binary image is a specific pixel (the foreground), the corresponding pixel in the second edge image will be determined as the specific pixel; otherwise, that is, if none of corresponding pixels in the first edge image and the binary image is a specific pixel (the foreground), the corresponding pixel in the second edge image will be determined as a non-specific pixel (the background).

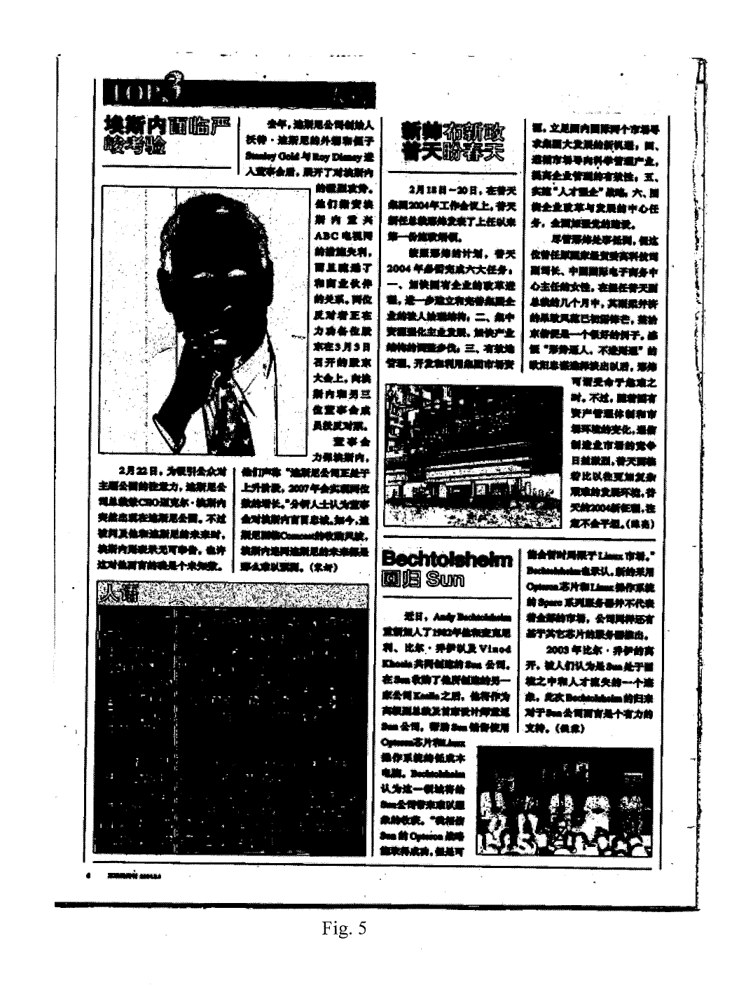

Particularly, if the foreground in the first edge image and the binary image is represented as 0 (black), an AND operation will be performed on the values of the corresponding pixels in the first edge image and the binary image. If the foreground in the first edge image and the binary image is represented as 1 (white), an OR operation will be performed on the values of the corresponding pixels in the first edge image and the binary image. The second edge image is generated as a result of the AND operation/OR operation. FIG. 5 illustrates an example of the second edge image

After the step S3 is performed, the specific region can be extracted based upon the second edge image (step S4).

In the step S4, the specific region is determined according to the second edge image.

It shall be noted that according to a preferred embodiment, a third edge image can be further generated based upon the second edge image, and then the step S4 can be performed on the third edge image to thereby improve the effect of the process.

The third edge image can be obtained by connecting local isolated pixels in the second edge image.

These local isolated pixels appear because some color zone is doped with a white background so that the pixels extracted in the step S2 above may be incomplete, thus resulting in the local isolated pixels. Actually, said color zone shall be extracted as a whole, so the local isolated pixels need to be connected into the foreground zone.

Particularly, the second edge image can be scanned using a connection template, e.g., a 5×5 template. If the number of specific pixels (the foreground) in the template is above a predetermined connection threshold, then a pixel corresponding to the center of the connection template will also be set as a specific pixel (the foreground). Of course, the 5×5 template is merely an example. The connection threshold can be set flexibly by those skilled in the art so that the local pixels in the second edge image can be connected together to obtain the third edge image.

Moreover, the second edge image can be de-noised directly, or the second edge image for which the local pixels are connected together can be de-noised, to obtain the third edge image.

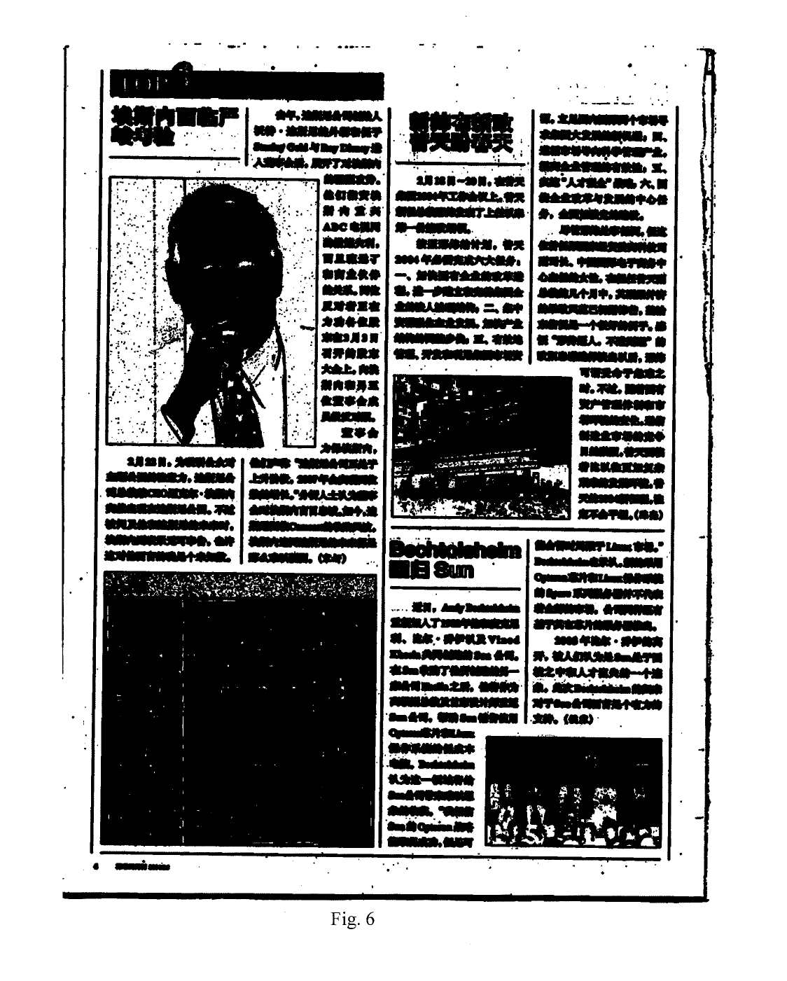

FIG. 6 illustrates an example of the third edge image.

The step above of connecting the local isolated pixels is an optional step. In the step S4, the specific region can be determined based upon the second edge image directly or based upon the third edge image. The following description will be given taking the third edge image as an example.

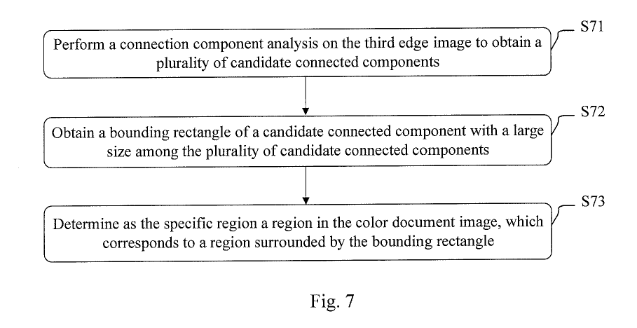

FIG. 7 illustrates a flow chart of a method for determining a specific region.

Since the invention is intended to extract a region instead of a pixel, as illustrated in FIG. 7, firstly a connection component analysis is made on the third edge image to obtain a plurality of candidate connected components in the step S71. The connection component analysis is common image processing in the art, so a repeated description thereof will be omitted here.

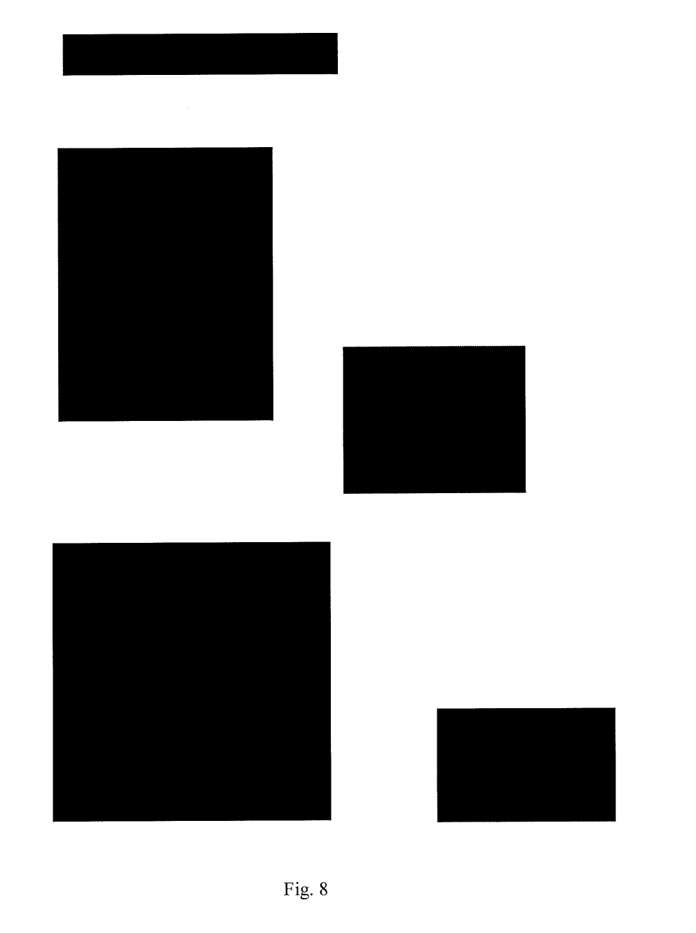

Then in the step S72, a bounding rectangle of a candidate connected component with a large size among the plurality of candidate connected components is obtained. Candidate connected components with sizes below a specific size threshold are precluded because a candidate connected component with a too small size may be an individual word instead of a region to be extracted, e.g., the color texts “ [symbol] ”, “ [symbol] [symbol] ”, and “Bechtolsheim” in FIG. 1. A bounding rectangle of a candidate connected component can be obtained for the candidate connected component as common image processing in the prior art, so a repeated description thereof will be omitted here. FIG. 8 illustrates an example of the bounding rectangle surrounding the region.

Lastly, in the step S73, a region in the color document image, which corresponds to a region surrounded by the bounding rectangle is determined as the specific region.

The bounding rectangle lies in the third edge image, and the specific region to be extracted lies in the original color document image, so a region in the color document image, which corresponds to the region surrounded the bounding rectangle will be determined as the extracted specific region.

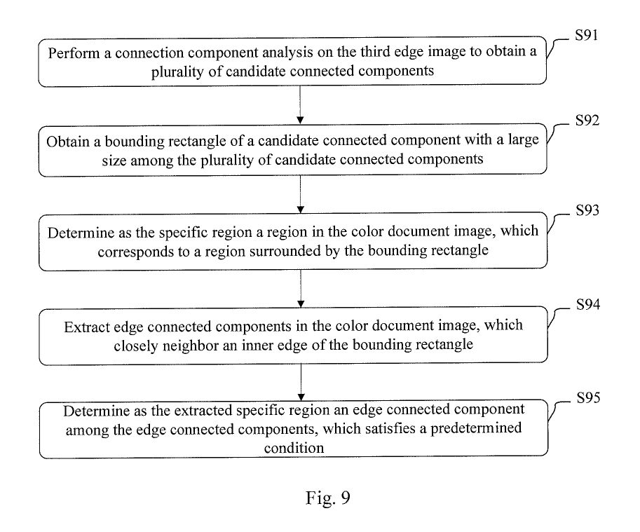

FIG. 9 illustrates a flow chart of another method for determining a specific region.

In the step S91, a connection component analysis is made on the third edge image to obtain a plurality of candidate connected components. In the step S92, a bounding rectangle of a candidate connected component with a large size among the plurality of candidate connected components is obtained. In the step S93, a region in the color document image, which corresponds to a region surrounded by the bounding rectangle is determined as a pending region. In the step S94, edge connected components in the color document image, which closely neighbor an inner edge of the bounding rectangle are extracted. In the step S95, only an edge connected component among the edge connected components, which satisfies a predetermined condition is determined as the extracted specific region.

Here the steps S91 to S93 are the same as the steps S71 to S73 except the result of determination in S93 needs to be adjusted slightly and thus will be referred to as a pending region. The zones closely neighboring the inner edge of the bounding rectangle are analyzed in the steps S94 and S95 to judge whether they satisfy the predetermined condition to thereby judge whether to extract them as the specific region.

Particularly, in the step S94, edge connected components in the color document image, which closely neighbor the inner edge of the bounding rectangle.

It shall be noted that the edge connected components are extracted in this step for the original color document image.

Whether to preclude the edge connected components in the color document image, which closely neighbor the inner edge of the bounding rectangle is judged according to whether the edge connected components satisfy the predetermined condition.

In the step S95, edge connected components which do not satisfy the predetermined condition are precluded from the pending region, that is, only an edge connected component among the edge connected components, which satisfies the predetermined condition is kept as the extracted specific region.

The predetermined condition defines the difference between a pixel in an edge connected component and a surrounding background, and uniformity throughout the edge connected component. For example the predetermined condition includes that a variance of all pixel values in the edge connected component is higher than a variance threshold, or that a difference between a mean value of all pixel values in the edge connected component, and a mean value of neighboring pixels outside the bounding rectangle is greater than a second difference threshold. The variance threshold and the second difference threshold can be set flexibly by those skilled in the art. An adjacent pixel outside the bounding rectangle refers to a pixel outside the bounding rectangle, which is adjacent to the edge connected component.

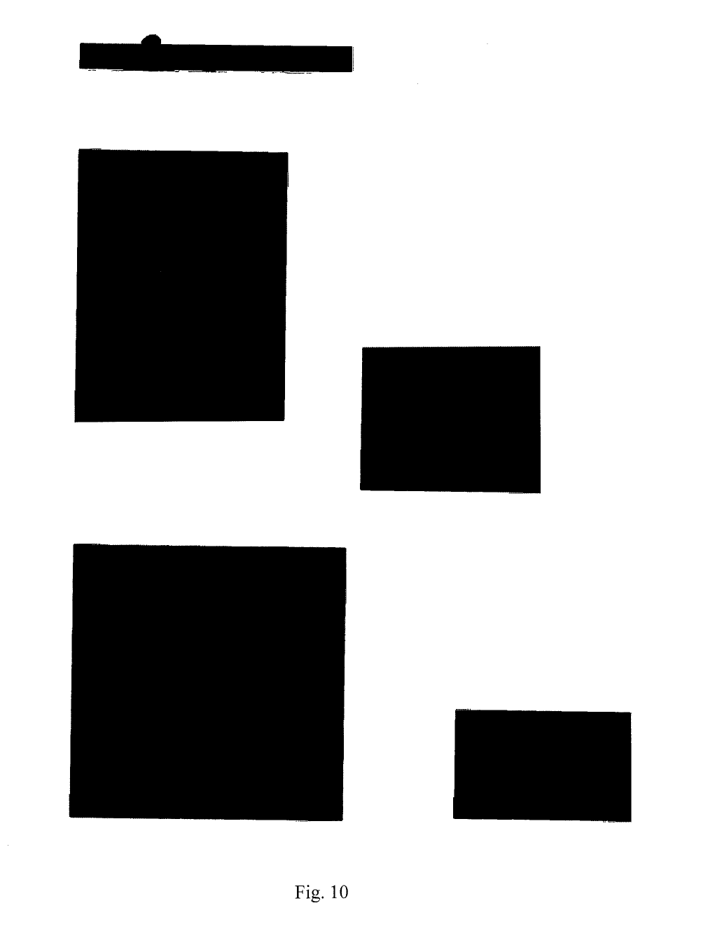

The desirable specific region has been extracted through the step S4. FIG. 10 illustrates a mask image corresponding to the extracted specific region, where a black region corresponds to a specific region, and a white region corresponds to a text region.

As can be apparent from FIG. 1, in the black box at the top left corner, the regions on the left and the right of the upper half of “3” in “TOP 3” are actually the background instead of the foreground, but “3” is the foreground. In FIG. 8, the regions surrounded by the bounding rectangles include background pixels on the left and the right of the upper half of “3”. Referring to FIG. 10, non-foreground pixels on the left and the right of the upper half of “3” are precluded from the pending region, and “3” is kept as a foreground region, through the steps S94 and S95. Moreover, the edges of the respective bounding rectangles in FIG. 8 are either horizontal or vertical, and in FIG. 10, the edge of the extracted specific region is burred as a result of extracting and analyzing the edge connected components. Apparently, the edge connected components nearby the inner edge of the bounding rectangle can be further analyzed to thereby extract the specific region more precisely. Moreover, there is an open region bound by lines in the color document image, such a region may be shown as the foreground in the second or third edge image obtained in the step S, but can be precluded in the steps S94 and S95, so that the finally extracted specific region is consisted of the closed region bound by lines.

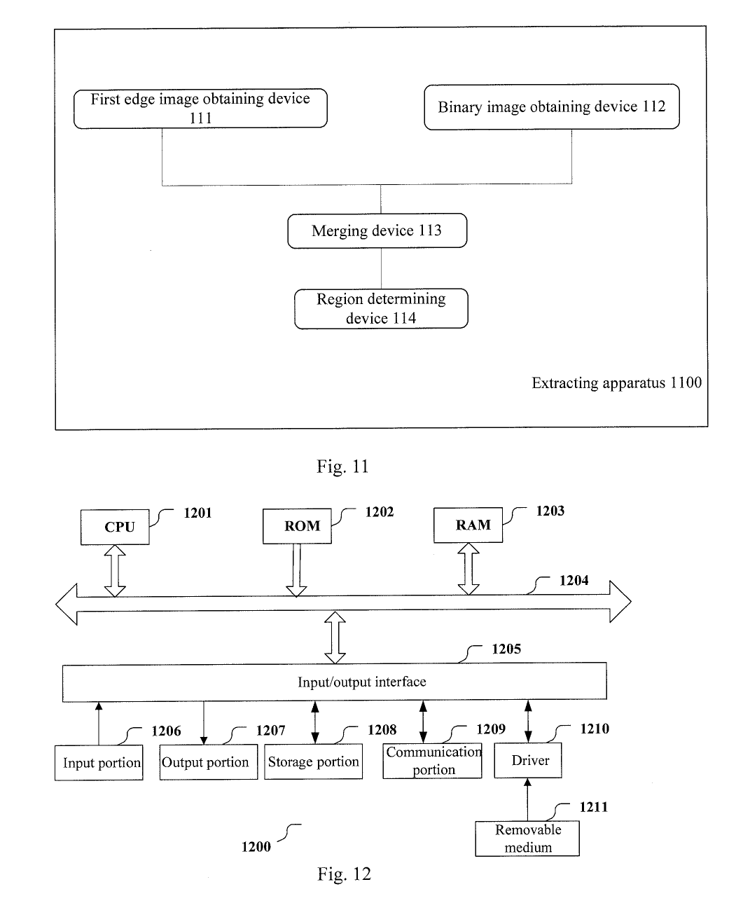

A device for extracting a specific region from a color document image according to an embodiment of the invention will be described below with reference to FIG. 11.

FIG. 11 illustrates a structural diagram of an apparatus for extracting a specific region from a color document image according to an embodiment of the invention. As illustrated in FIG. 11, the extracting apparatus 1100 according to the invention includes: a first edge image acquiring device 111 configured to obtain a first edge image according to the color document image; a binary image obtaining device 112 configured to acquire a binary image using non-uniformity of color channels; a merging device 113 configured to merge the first edge image and the binary image to obtain a second edge image; and a region determining device 114 configured to determine the specific region according to the second edge image.

In an embodiment, the specific region includes: at least one of a picture region, a half-tone region, and a closed region bound by lines.

In an embodiment, the binary image obtaining device 112 is further configured to compare a difference among three channels R, G, B of each pixel in the color document image; and to determine, based on whether the difference is greater than a first difference threshold, a value of a pixel in the binary image, which corresponds to the pixel.

In an embodiment, the merging device 113 is further configured: if at least one of corresponding pixels in the first edge image and the binary image is a specific pixel, to determine the corresponding pixel in the second edge image as the specific pixel.

In an embodiment, the region determining device 114 includes: a connected component analyzing unit configured to perform a connected component analysis on the second edge image to obtain a plurality of candidate connected components; a bounding rectangle obtaining unit configured to obtain a bounding rectangle of a candidate connected component with a large size among the plurality of candidate connected components; and a region determining unit configured to determine, as the specific region, a region in the color document image which corresponds to a region surrounded by the bounding rectangle.

In an embodiment, the region determining device 114 further includes: an edge connected component extracting unit configured to extract edge connected components in the color document image, which closely neighbor an inner edge of the bounding rectangle; and the region determining unit is further configured to determine, as a part of the specific region, only an edge connected component among the edge connected components, which satisfies a predetermined condition.

In an embodiment, the predetermined condition includes that a variance of all pixel values in the edge connected component is higher than a variance threshold, or that a difference between a mean value of all pixel values in the edge connected component, and a mean value of neighboring pixels outside the bounding rectangle is greater than a second difference threshold.

In an embodiment, the region determining device 114 further includes: a connecting unit configured to connect local points in the second edge image to obtain a third edge image; and the region determining unit is further configured to determine the specific region according to the third edge image.

In an embodiment, the connecting unit is further configured to scan the second edge image using a connection template; to determine, as the specific pixel, a pixel to which a center of the connection template corresponds, if a number of specific pixels in the connection template exceeds a connection threshold; and to modify the second edge image according to the determination result, to obtain the third edge image.

In an embodiment, there is provided a scanner including the extracting apparatus 1100 as described above.

The processes in the respective devices and units in the extracting apparatus 1100 according to the invention are similar respectively to those in the respective steps in the extracting method described above, so a detailed description of these devices and units will be omitted here for the sake of conciseness.

Moreover, it shall be noted that the respective devices and units in the apparatus above can be configured in software, firmware, hardware or any combination thereof. How to particularly configure them is well known to those skilled in the art, so a detailed description thereof will be omitted here. In the case of being embodied in software or firmware, program constituting the software or firmware can be installed from a storage medium or a network to a computer with a dedicated hardware structure (e.g., a general-purpose computer 1200 illustrated in FIG. 12) which can perform various functions of the units, sub-units, modules, etc., above when various pieces of programs are installed thereon.

FIG. 12 illustrates a schematic block diagram of a computer in which the method and the apparatus according to the embodiments of the invention can be embodied.

In FIG. 12, a Central Processing Unit (CPU) 1201 performs various processes according to program stored in a Read Only Memory (ROM) 1202 or loaded from a storage portion 1208 into a Random Access Memory (RAM) 1203 in which data required when the CPU 1201 performs the various processes, etc., is also stored as needed. The CPU 1201, the ROM 1202, and the RAM 1203 are connected to each other via a bus 1204 to which an input/output interface 1205 is also connected.

The following components are connected to the input/output interface 1205: an input portion 1206 (including a keyboard, a mouse, etc.), an output portion 1207 (including a display, e.g., a Cathode Ray Tube (CRT), a Liquid Crystal Display (LCD), etc., a speaker, etc.), a storage portion 1208 (including a hard disk, etc.), and a communication portion 1209 (including a network interface card, e.g., an LAN card, an MODEM, etc). The communication portion 1209 performs a communication process over a network, e.g., the Internet. A driver 1210 is also connected to the input/output interface 1205 as needed. A removable medium 1211, e.g., a magnetic disk, an optical disk, an optic-magnetic disk, a semiconductor memory, etc., can be installed on the driver 1210 as needed so that computer program fetched therefrom can be installed into the storage portion 1208 as needed.

In the case that the foregoing series of processes are performed in software, program constituting the software can be installed from a network, e.g., the Internet, etc., or a storage medium, e.g., the removable medium 1211, etc.

Those skilled in the art shall appreciate that such a storage medium will not be limited to the removable medium 1211 illustrated in FIG. 12 in which the program is stored and which is distributed separately from the apparatus to provide a user with the program. Examples of the removable medium 1211 include a magnetic disk (including a Floppy Disk), an optical disk (including Compact Disk-Read Only memory (CD-ROM) and a Digital Versatile Disk (DVD)), an optic-magnetic disk (including a Mini Disk (MD) (a registered trademark)) and a semiconductor memory. Alternatively, the storage medium can be the ROM 1202, a hard disk included in the storage portion 1208, etc., in which the program is stored and which is distributed together with the apparatus including the same to the user.

The invention further proposes a product program on which machine readable instruction codes are stored. The instruction codes can perform the method above according to the embodiment of the invention upon being read and executed by a machine.

Correspondingly, a storage medium carrying the program product above on which the machine readable instruction codes are stored will also be encompassed in the disclosure of the invention. The storage medium can include but will not be limited to a floppy disk, an optical disk, an optic-magnetic disk, a memory card, a memory stick, etc.

In the foregoing description of the particular embodiments of the invention, a feature described and/or illustrated with respect to an implementation can be used identically or similarly in one or more other implementations in combination with or in place of a feature in the other implementation(s).

It shall be noted that the term “include/comprise” as used in this context refers to the presence of a feature, an element, a step or a component but will not preclude the presence or addition of one or more other features, elements, steps or components.

Furthermore, the method according to the invention will not necessarily be performed in a sequential order described in the specification, but can alternatively be performed sequentially in another sequential order, concurrently or separately. Therefore, the technical scope of the invention will not be limited by the order in which the methods are performed as described in the specification.

Although the invention has been disclosed above in the description of the particular embodiments of the invention, it shall be appreciated that all the embodiments and examples above are illustrative but not limiting. Those skilled in the art can make various modifications, adaptations or equivalents to the invention without departing from the spirit and scope of the invention. These modifications, adaptations or equivalents shall also be regarded as falling into the scope of the invention.

1. A method for extracting a specific region from a color document image, the method including:
obtaining a first edge image according to the color document image;
acquiring a binary image using non-uniformity of color channels;
merging the first edge image and the binary image to obtain a second edge image; and
determining the specific region according to the second edge image.

2. The method according to annex 1, wherein the specific region includes: at least one of a picture region, a half-tone region, and a closed region bound by lines.

3. The method according to annex 1, wherein the acquiring a binary image using non-uniformity of color channels includes:
comparing a difference among three channels R, G, B of each pixel in the color document image; and
determining, based on whether the difference is greater than a first difference threshold, a value of a pixel in the binary image, which corresponds to the pixel.

4. The method according to annex 1, wherein the merging the first edge image and the binary image to obtain a second edge image includes: if at least one of corresponding pixels in the first edge image and the binary image is a specific pixel, determining the corresponding pixel in the second edge image as the specific pixel.

5. The method according to annex 1, wherein the determining the specific region according to the second edge image includes:
performing a connected component analysis on the second edge image to obtain a plurality of candidate connected components;
obtaining a bounding rectangle of a candidate connected component with a large size among the plurality of candidate connected components; and
determining, as the specific region, a region in the color document image, which corresponds to a region surrounded by the bounding rectangle.

6. The method according to annex 5, further including:
extracting edge connected components in the color document image, which closely neighbor an inner edge of the bounding rectangle; and
determining, as a part of the specific region, only an edge connected component among the edge connected components, which satisfies a predetermined condition.

7. The method according to annex 6, wherein the predetermined condition includes that a variance of all pixel values in the edge connected component is higher than a variance threshold, or that a difference between a mean value of all pixel values in the edge connected component, and a mean value of neighboring pixels outside the bounding rectangle is greater than a second difference threshold.

8. The method according to annex 1, wherein the determining the specific region according to the second edge image includes:
connecting local pixels in the second edge image to obtain a third edge image; and
determining the specific region according to the third edge image.

9. The method according to annex 8, wherein the connecting local pixels in the second edge image to obtain a third edge image includes:
scanning the second edge image using a connection template;
determining, as the specific pixel, a pixel to which a center of the connection template corresponds, if a number of specific pixels in the connection template exceeds a connection threshold; and
modifying the second edge image according to the determination result, to obtain the third edge image.

10. The method according to annex 1, further including: determining a region in the color document image other than the specific region as a text region.

11. An apparatus for extracting a specific region from a color document image, including:
a first edge image acquiring device configured to obtain a first edge image according to the color document image;
a binary image obtaining device configured to acquire a binary image using non-uniformity of color channels;
a merging device configured to merge the first edge image and the binary image to obtain a second edge image; and
a region determining device configured to determine the specific region according to the second edge image.

12. The apparatus according to annex 11, wherein the specific region includes:
at least one of a picture region, a half-tone region, and a closed region bound by lines.

13. The apparatus according to annex 11, wherein the binary image obtaining device is further configured:
to compare a difference among three channels R, G, B of each pixel in the color document image; and
to determine, based on whether the difference is greater than a first difference threshold, a value of a pixel in the binary image, which corresponds to the pixel.

14. The apparatus according to annex 11, wherein the merging device is further configured: if at least one of corresponding pixels in the first edge image and the binary image is a specific pixel, to determine the corresponding pixel in the second edge image as the specific pixel.

15. The apparatus according to annex 11, wherein the region determining device includes:
a connected component analyzing unit configured to perform a connected component analysis on the second edge image to obtain a plurality of candidate connected components;
a bounding rectangle obtaining unit configured to obtain a bounding rectangle of a candidate connected component with a large size among the plurality of candidate connected components; and
a region determining unit configured to determine, as the specific region, a region in the color document image which corresponds to a region surrounded by the bounding rectangle.

16. The apparatus according to annex 15, wherein the region determining device further includes:
an edge connected component extracting unit configured to extract edge connected components in the color document image, which closely neighbor an inner edge of the bounding rectangle; and
the region determining unit is further configured to determine, as a part of the specific region, only an edge connected component among the edge connected components, which satisfies a predetermined condition.

17. The apparatus according to annex 16, wherein the predetermined condition includes that a variance of all pixel values in the edge connected component is higher than a variance threshold, or that a difference between a mean value of all pixel values in the edge connected component, and a mean value of neighboring pixels outside the bounding rectangle is greater than a second difference threshold.

18. The apparatus according to annex 11, wherein the region determining device further includes:
a connecting unit configured to connect local points in the second edge image to obtain a third edge image; and
the region determining device is further configured to determine the specific region according to the third edge image.

19. The apparatus according to annex 18, wherein the connecting unit is further configured:
to scan the second edge image using a connection template;
to determine, as the specific pixel, a pixel to which a center of the connection template corresponds, if a number of specific pixels in the connection template exceeds a connection threshold; and
to modify the second edge image according to the determination result, to obtain the third edge image.

20. A scanner, including the apparatus according to any one of annexes 11 to 19.
